(19) United States
(12) Patent Application Publication
(10) Pub. No.: US 2014/0344073 A1
(43) Pub. Date: Nov. 20, 2014

(54) REAL-TIME ADVERTISEMENT BIDDING

(71) Applicant: MICROSOFT CORPORATION, Redmond, WA (US)

(72) Inventors: TAK YAN, Palo Alto, CA (US); Qing Lu, Santa Clara, CA (US); Sendillnathan Arunchalam, San Jose, CA (US); Ye Chen, Sunnyvale, CA (US); Jian Yuan, Foster City, CA (US)

(73) Assignee: MICROSOFT CORPORATION, Redmond, WA (US)

(21) Appl. No.: 13/894,380

(22) Filed: May 14, 2013

(51) Int. Cl. G06Q 30/02

(52) U.S. Cl. CPC G06Q 30/0275
USPC 705/14.71

(57) ABSTRACT

Embodiments of the present invention are directed to systems and methods for facilitating real-time bidding in paid search. In some implementations, a real-time bidding agent receives advertisement context data that is related to presentation of an advertisement in response to a search query. Thereafter, a determination is made as to providing a real-time bid and a real-time advertisement for participation in an advertisement auction associated with the search query using the advertisement context data. A desired real-time bid and real-time advertisement can then be provided to an advertisement selection server for participation in the advertisement auction associated with the search query.

### BACKGROUND

Online advertising can include presenting an advertisement within an electronic document, such as a web page, served by a content server to a user device. The web page may include an area for presenting an advertisement. When a user requests a web page from a content server, an advertising delivery system may select an advertisement for presentation within the area provided by the web page.

Advertising delivery systems often select advertisements for delivery and presentation within a web page using an auction process. In particular, advertisers establish advertisement campaigns, which include an advertisement(s) that may be delivered for presentation on web pages and a corresponding bid price(s) used for advertisement selection. The auction process comprises comparing bid prices associated with competing advertisement campaigns and selecting the advertisement campaign having the highest bid price and/or the advertisement campaign determined likely to generate the highest advertising revenue for presentation of that advertisement.

Providing advertisements and corresponding bids is typically performed using advertisement campaign pre-settings. In this regard, such advertisements and/or bids are fixed by the advertiser when the advertisement campaign is established or modified at a later time. As the advertisements and bids are established prior to reception of a user search query, this provides a particularly rigid approach to targeting advertisements to users. In some instances, some flexibility may be provided by configuring an advertisement campaign to target specific types of users. This approach, however, still limits the ability to dynamically provide an advertisement and/or corresponding bid in specific instances.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Embodiments of the present invention relate to facilitating real-time bidding. In this regard, upon reception of a user search query, an advertiser (e.g., by way of a real-time bidding agent) is given an opportunity to provide a real-time bid and/or a real-time advertisement for participating in an advertisement auction for the received search query. The real-time bid and/or real-time advertisement to be provided for use in an advertisement auction can be determined based on context data associated with the advertisement, such as the submitted search query, user attributes indicating or describing the user or user actions, or the like. As such, based on the context associated with the received query, the advertiser can determine whether to modify or adjust a previously submitted advertisement or corresponding bid for participation in the advertisement auction. In this way, the advertiser can improve chances that the advertisement is selected for display if so desired given the context of the advertiser display.

### BRIEF DESCRIPTION OF THE DRAWINGS

The present invention is described in detail below with reference to the attached drawing figures, wherein:

FIG. 1 is a block diagram of an exemplary computing environment suitable for use in implementing embodiments of the present invention;

FIG. 2 is a block diagram of an exemplary system in which embodiments of the invention may be employed;

FIG. 3 is a flow diagram showing a method for facilitating presentation of advertisements selected based on real-time bidding in accordance with an embodiment of the present invention;

FIG. 4 is a flow diagram showing a method for facilitating inputting advertisement settings in accordance with an embodiment of the present invention;

FIG. 5 is a flow diagram showing a first method for facilitating real-time bidding in accordance with an embodiment of the present invention; and

FIG. 6 is a flow diagram showing a second method for facilitating real-time bidding in accordance with an embodiment of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

As noted above, embodiments of the present invention relate to facilitating real-time bidding in paid search. In this regard, upon reception of a user search query, an advertiser (e.g., by way of a real-time bidding agent) is given an opportunity to provide a real-time bid and/or a real-time advertisement for participating in an advertisement auction for the received search query. The real-time bid and/or real-time advertisement to be provided for use in an advertisement auction can be determined based on context data associated with the advertisement, such as the submitted search query, user attributes indicating or describing the user or user actions, or the like. As such, based on the context associated with the received query, the advertiser can determine whether to modify or adjust a previously submitted advertisement or corresponding bid for participation in the advertisement auction. In this way, the advertiser can improve chances that the advertisement is selected for display if so desired given the context of the advertiser display.

Accordingly, in one aspect, an embodiment of the present invention is directed to one or more computer storage media storing computer-useable instructions that, when used by a computing device, cause the computing device to perform a method. The method includes receiving an advertisement and a corresponding advertisement bid for participation in advertisement auctions. The method also includes receiving an indication of a desire to partake in real-time bidding at least for one or more advertisement auctions in which the advertisement is participating. The advertisement, the corresponding advertisement bid, and the indication of the desire to partake in real-time bidding are provided such that real-time bidding is eligible for subsequent advertisement auctions in which the advertisement is participating. The real-time bidding enables provision of at least a real-time bid or a real-time advertisement for participation in the subsequent advertisement auctions associated with received search queries.

In another embodiment, an aspect of the invention is directed to one or more computer storage media storing a real-time bidding agent, the real-time bidding agent including a receiving component, a determining component, and a providing component. The receiving component receiving advertisement context data that is related to presentation of an advertisement in response to a search query. The determining component determining a real-time bid and a real-time advertisement for participation in an advertisement auction associated with the search query using the advertisement context data. The providing component providing to an advertisement selection server the real-time bid and the real-time advertisement for participation in the advertisement auction associated with the search query.

A further embodiment is directed to one or more computer storage media storing computer-useable instructions that, when used by a computing device, cause the computing device to perform a method. The method includes receiving an advertisement and a corresponding advertisement bid provided by an advertiser and receiving a user search query provided by a user. In accordance with the user search query, the advertisement is selected for participation in an advertisement auction. An indication of the selected advertisement, at least a portion of the user search query, and one or more user attributes associated with the user are provided to a real-time bidding agent associated with the advertiser. A real-time bid and a real-time advertisement from the real-time bidding agent are received for use in the advertisement auction associated with the user search query. Thereafter, at least the real-time bid is used for participation in the advertisement auction, wherein the advertisement auction performs selection of one or more advertisements to present in accordance with the user search query.

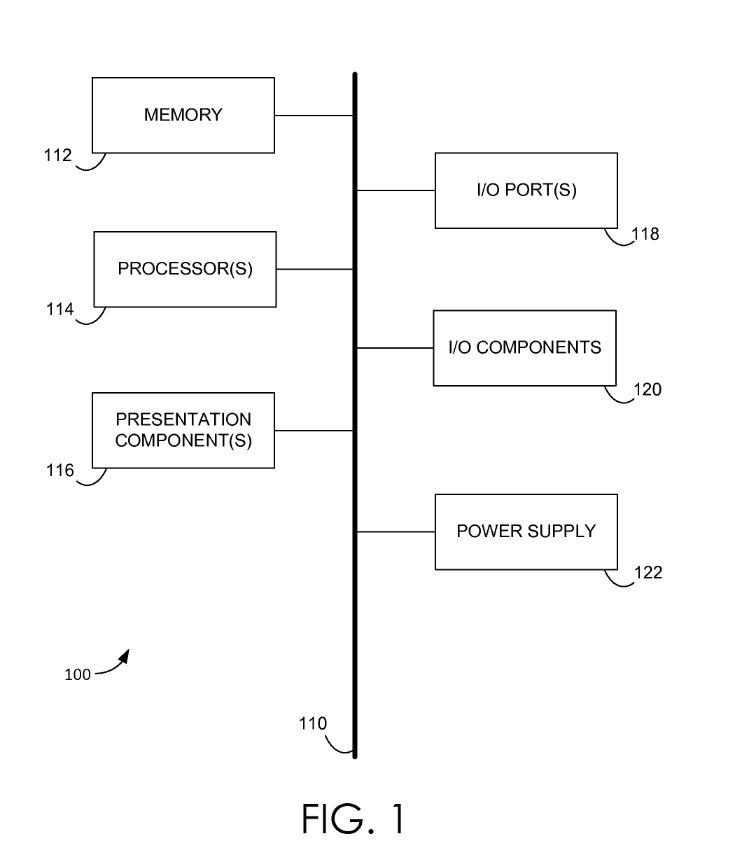

Having briefly described an overview of embodiments of the present invention, an exemplary operating environment in which embodiments of the present invention may be implemented is described below in order to provide a general context for various aspects of the present invention. Referring initially to FIG. 1 in particular, an exemplary operating environment for implementing embodiments of the present invention is shown and designated generally as computing device 100. Computing device 100 is but one example of a suitable computing environment and is not intended to suggest any limitation as to the scope of use or functionality of the invention. Neither should the computing device 100 be interpreted as having any dependency or requirement relating to any one or combination of components illustrated.

The invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The invention may be practiced in a variety of system configurations, including hand-held devices, consumer electronics, general-purpose computers, more specialty computing devices, etc. The invention may also be practiced in distributed computing environments where tasks are performed by remote-processing devices that are linked through a communications network.

With reference to FIG. 1, computing device 100 includes a bus 110 that directly or indirectly couples the following devices: memory 112, one or more processors 114, one or more presentation components 116, input/output (I/O) ports 118, input/output components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computing device.”

Computing device 100 typically includes a variety of computer-readable media. Computer-readable media can be any available media that can be accessed by computing device 100 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 100. Communication media, on the other hand, typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. As defined herein, computer storage media does not include communication media. Combinations of any of the above should also be included within the scope of computer-readable media.

Memory 112 includes computer-storage media in the form of volatile and/or nonvolatile memory. The memory may be removable, non-removable, or a combination thereof. Exemplary hardware devices include solid-state memory, hard drives, optical-disc drives, etc. Computing device 100 includes one or more processors that read data from various entities such as memory 112 or I/O components 120. Presentation component(s) 116 present data indications to a user or other device. Exemplary presentation components include a display device, speaker, printing component, vibrating component, etc.

I/O ports 118 allow computing device 100 to be logically coupled to other devices including I/O components 120, some of which may be built in. Illustrative components include a microphone, joystick, game pad, satellite dish, scanner, printer, wireless device, etc.

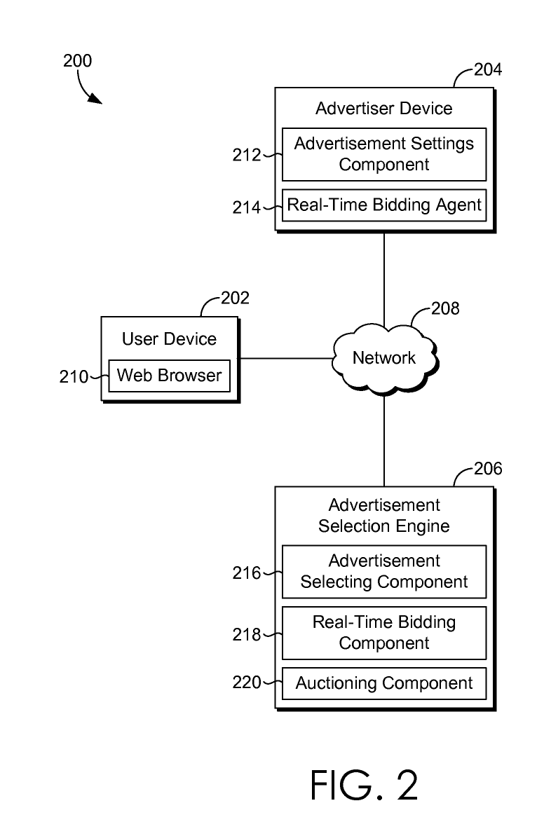

Referring now to FIG. 2, a block diagram is provided illustrating an exemplary system 200 in which embodiments of the present invention may be employed. It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

Among other components not shown, the system 200 includes a user device 202, an advertiser device 204, and an advertisement selection engine 206. Each of the components shown in FIG. 2 may be any type of computing device, such as computing device 100 described with reference to FIG. 1, for example. The components may communicate with each other via a network 208, which may include, without limitation, one or more local area networks (LANs) and/or wide area networks (WANs). Such networking environments are commonplace in offices, enterprise-wide computer networks, intranets, and the Internet. It should be understood that any number of user devices, advertiser devices, and advertisement selection engines may be employed within the system 200 within the scope of the present invention. Each may comprise a single device or multiple devices cooperating in a distributed environment. For instance, the advertisement selection engine 206 may comprise multiple devices arranged in a distributed environment that collectively provide the functionality of the advertisement selection engine 206 described herein. Additionally, other components not shown may also be included within the system 200, while components shown in FIG. 2 may be omitted in some embodiments.

The user device 202 may be any type of computing device owned and/or operated by a user that can access network 208. For instance, the user device 202 may be a desktop computer, a laptop computer, a tablet computer, a mobile device, or any other device having network access. Generally, a user may employ the user device 202 to, among other things, access electronic documents maintained by content servers (not shown). For example, the user may employ a web browser 210 on the user device 202 to access and view electronic documents from one or more content servers. Such content servers may be any type of server device capable of hosting electronic documents from a publisher and serving the electronic documents to computing devices, such as the user device 202. By way of example, and not limitation, a content server may be a server maintaining web pages for a publisher website.

Space may be provided on a presented web page for presenting advertisements. In particular, when a user accesses a web page from a content server, the advertisement selection engine 206 may facilitate selection and delivery of an advertisement(s) for presentation within the web page. In some embodiments, a web page accessed by a user may be a web page for a search engine to allow a user to search for relevant data. In such a case, a user may enter, input, or otherwise provide a search query (i.e., one or more search terms) for which related information is desired. A search query can be input via a search box associated with the search web page. Exemplary Internet search engines are well known in the art, for instance, a commonly known commercial engine is the BING search engine provided by Microsoft Corporation of Redmond, Wash. In other embodiments, a web page accessed by a user may be any web page. In any case, when a user requests a web page, such as a search results web page from a content server(s), the advertisement selection engine 206 can select an advertisement for presentation within an area(s) provided by the web page.

Upon the web browser 210 of the user device 202 obtaining the web page and/or selected advertisement(s), the web browser 210 can cause display such that the user of the user device 202 can view the webpage and corresponding advertisement(s). The web browser 210 is configured to render a web page(s), such as a search results web page. By way of example only, assume that a user submits a search query via a search web page (e.g., Bing®). In response, the search results web page having a corresponding advertisement(s) deemed relevant to the webpage or search query can be presented to the user on a display via the web browser 210.

The advertiser device 204 may be any type of computing device owned and/or operated by an advertiser, or representative thereof, that can access a network (e.g., network 208). For instance, the advertiser device 204 may be a desktop computer, a laptop computer, a tablet computer, a mobile device, a server, or any other device having network access. Generally, an advertiser may employ the advertiser device 204 to, among other things, manage presentation of advertisements associated with the advertiser. An advertiser may be an individual or a representative of a company, an association, an organization, an institution, etc. that facilitates submission of an advertisement, or data associated therewith, for use in electronic display.

In embodiments, the advertiser device 204 includes advertisement settings component 212 and real-time bidding agent 214. The advertisement settings component 212 is configured to facilitate providing advertisement data, advertisement preferences, and real-time bidding preferences. Advertisement data refers to any data indicating, describing, or associated with an advertisement or set of advertisements (e.g., within an advertisement campaign). In embodiments, advertisement data may be the advertisement, a description of the advertisement, an identification of the advertisement, a title of the advertisement, a display URL, a destination URL, an image, an identification of the advertiser, a designation of an advertisement campaign associated with the advertisement, or the like. Advertisement preferences refer to preferences of the advertisement for selecting or presenting corresponding advertisements. By way of example, and without limitation, advertisement preferences may include an advertisement bid, an advertisement keyword, a display preference, or the like.

An advertisement bid refers to a bid or monetary value the advertiser is willing to pay for presentation, selection, or conversion (or action) of a particular advertisement or one of a set of advertisements. For example, an advertiser may indicate a bid of ten cents to display an advertisement related to a particular restaurant. As another example, an advertiser might indicate a bid of ten cents when one of a group of advertisements is presented for display and results in a selection of the advertisement (e.g., click through) or a conversion (e.g., a user purchases an item for sale, user completes and submits a form, etc.).

An advertisement keyword refers to a term or phrase associated with an advertisement for which an advertiser places a bid. In other words, an advertisement keyword refers to a term or phrase for which the advertiser would like an advertisement displayed. In this way, when a particular term or phrase is present in a search query or web content, the advertiser would like a corresponding advertisement to be displayed. As can be appreciated, a particular advertisement may be associated with any number of keywords. Further, a set of one or more keywords can be associated with a group of advertisements.

A display preference refers to a preference associated with selection and/or presentation of an advertisement or a set of advertisements. For example, an advertiser might select optimal dates or times at which an advertisement is preferred to be displayed. As another example, an advertiser might select user attributes that are desired to be present or absent for selection and/or presentation of an advertisement(s). For instance, an advertiser might indicate a preference that an advertisement be provided when the user is known or predicted to be a female, when the user is located in a particular geographic region, when the user has indicated a preference for a particular item, etc.

Real-time bidding preferences refer to preferences related to participation in real-time bidding. Real-time bidding preferences might include an indication of whether the advertiser wants to participate in real-time bidding and/or a value or amount the advertiser will pay to participate in real-time bidding (e.g., pay per period, pay per call, pay per participation, pay per click through or conversion resulting in participation of auction, etc.). Additionally or alternatively, real-time bidding preferences might be preferences or criteria selected by an advertiser or input by an advertiser that are associated with initiating real-time bidding with the corresponding advertiser. In this regard, an advertiser can designate in what instances and/or in what manner the advertiser (e.g., real-time bidding agent 214) would like to participate in real-time bidding. By way of example only, the advertiser might specify a desire to participate in real-time bidding when the user is of a certain demographic, the user is identified as being in a certain location, a particular advertisement or set of advertisements is selected, a particular time and/or day preference, etc. As such, an advertiser can specify preferences or criteria associated with the real-time bidding process (e.g., at the time of campaign creation or thereafter).

To input advertisement data, advertisement preferences, and/or real-time bidding preferences, a web browser or application on the advertiser device 204 (or other computing device) may be used. An advertiser can input advertisement data, advertisement preferences, and/or real-time bidding preferences into advertiser device 204 in any number of manners, for example, using an advertising user interface that enables an advertiser to input, provide, or select advertising data. For example, an advertiser may employ a web browser on the advertiser device 204 to access and view an advertiser account that enables the advertiser to provide and/or manage advertisement selection and/or display. Such advertisement data, advertisement preferences, and/or real-time bidding preferences can be input, for instance, at account creation or at a time subsequent to creating an account (e.g. to add or modify preferences).

Advertisement data, advertisement preferences, and/or real-time bidding preferences can be stored at the advertiser device 204 and/or communicated to the advertisement selection engine 206 (or other component) for storage in association therewith. In some embodiments, such data is communicated to the advertisement selection engine 206 for use in selecting and/or presenting advertisements, as described more fully below. In additional or alternative embodiments, the advertisement data, advertisement preferences, and/or real-time bidding preferences may reside or be accessible at the advertiser device 204 or other advertiser device such that the advertiser device 204 selects and provides advertisements and bids in real-time. For example, advertisements might be maintained and stored remote from the advertisement selection engine 206. In such a case, when a user enters a search via the user device 202, the advertisement selection engine 206 can directly place a call or request to the advertiser device 204 with the query from the user to request an advertisement(s) to present and/or a corresponding bid(s). Accordingly, the real-time bidding component 218 of the advertisement selection engine 206 performs a call out to the real-time bidding agent 214 of the advertiser device 204 when a search query is received. In response, the real-time bidding agent 214 of the advertiser device 204 returns an appropriate advertisement(s) and corresponding bid(s) to be used in the auction for advertisements to be displayed in association with the search query.

The real-time bidding agent 214 facilitates real-time bidding for participation of an advertisement(s) in an advertisement auction. Generally, real-time bidding, as used herein, refers to providing, in real-time, advertisement bids and/or data related thereto, such as advertisement(s) or advertisement data. In this regard, the real-time bidding agent 214 is able to facilitate dynamically providing or modifying bids and/or advertisements for participation in an advertisement auction. As can be appreciated, the real-time bidding agent 214 can facilitate real-time bidding and/or advertisement provisioning in any number of manners including, for example, employing various rules, formulas, models, controllers, etc.

In implementation, the real-time bidding agent 214 receives a real-time auction indicator. A real-time auction indicator provides an indication that an advertisement auction is occurring or is about to occur in real-time such that the advertiser (e.g., real-time bidding agent) can participate in the real-time auction using a real-time bid and/or a real-time advertisement, as described in more detail below.

The real-time auction indicator may be provided along with advertisement context, that is, any type of information that might be valuable to the advertiser to determine whether to provide a real-time bid and/or a real-time advertisement and/or to determine a specific real-time bid and/or a real-time advertisement to provide. By way of example, and not limitation, the real-time bidding agent 214 may receive advertisement context including the particular search query for which an advertisement(s) is desired to be served, an indication or identification of the advertisement(s) selected by the advertisement selection engine 206 for participation in the advertisement auction, a user attribute(s) (e.g., a user demographic(s), a user geographical location, etc.).

Upon receiving the real-time auction indicator and/or corresponding advertisement context, the real-time bidding agent 214 can determine whether to provide a real-time bid and/or real-time advertisement and, if so, a value or content associated therewith. In this regard, the real-time bidding agent 214 can make real-time decisions. In embodiments, such real-time decisions are based on proprietary technologies or data that are not shared with the advertisement selection engine 206 through traditional advertisement campaign setup.

As used herein, a real-time bid refers to an advertisement bid that is provided in real-time just prior to or concurrent with the advertisement auction. In this regard, a real-time bid is an advertisement bid that is placed or indicated after a search query is submitted (or received) but prior to or concurrent with conducting the advertisement auction (e.g., at auctioning component 220 of the advertisement selection engine 206). Such a real-time bid might be a new bid that has not been previously provided or a modified bid of one that has been previously provided (e.g., via the advertisement settings component 212) to the advertisement selection engine 206.

A real-time advertisement refers to an advertisement that is provided in real-time just prior to or concurrent with the advertisement auction. In this regard, a real-time advertisement is an advertisement, or portion thereof, that is provided or indicated after a search query is submitted (or received) but prior to or concurrent with conducting the advertisement auction (e.g., at auctioning component 220 of the advertisement selection engine 206). Such a real-time advertisement might be a new advertisement that has not been previously provided, a modified advertisement of one that has been previously provided (e.g., via the advertisement settings component 212) to the advertisement selection engine 206, or advertisement data that includes data or content to include along with or supplement an advertisement that has been previously provided to the advertisement selection engine 206. Such a modification or supplement may include a modification or addition of text (e.g., advertisement title, advertisement caption or description, a display URL, a destination URL, etc.), images, formatting (e.g., highlighting, coloring, etc.), and/or the like.

In operation, the real-time bidding agent 214 can assess the advertisement selected for participation in the advertisement auction in combination with any available advertisement context (e.g., search query, user attributes, etc.) and determine whether and to what extent to provide a real-time bid(s) and/or real-time advertisement(s). The real-time bidding agent 214 may employ any number or manner of rules or algorithms to make such a decision. Such a determination might be based on, for instance, user attributes, the content query (e.g., keyword(s)), intent of the query (e.g., to purchase or acquire), value to the advertiser, time and/or date of query/auction, budget constraints of the advertiser, and/or the like.

By way of example only, assume that an advertiser originally provided an advertisement having an advertisement bid associated with the keywords “diamond ring.” In this way, the advertiser desired a particular advertisement to be shown whenever the keywords “diamond ring” appeared in a search query. Now assume that a user enters a query of “2 carat or higher diamond ring.” Upon the real-time bidding agent 214 of the advertiser device 204 receiving the search query, the agent might want to increase the initially provided advertisement bid to increase the chances that the selected advertisement is presented to the user. Additionally or alternatively, the real-time bidding agent 214 might wish to modify content in the advertisement to recite “2 carat diamond ring” in order to be more relevant and specific to the user's interests increasing the opportunity for an advertisement selection or conversion.

By way of another example, assume that an advertiser has advertisements pertaining to a telecommunications service. Further assume that the real-time bidding agent 214 receives advertising context indicating the user and that the user is interested in mobile device service plans. Upon recognizing that the user is a subscriber to the company's local plans and is a high-value subscriber, the real-time bidding agent 214 may wish to increase the previously-provided bid for a selected advertisement. Additionally or alternatively, the real-time bidding agent 214 may want to change the advertisement to offer an incentive for the user.

In determining whether to provide a real-time bid and/or a value (or adjustment) to provide for a real-time bid, the real-time bidding agent 214 can utilize received advertisement context, such as the search query and user attributes, to make such a determination(s). In some implementations, the real-time bidding agent 214 may be able to increase or decrease an original advertisement bid associated with an advertisement. In other implementations, the real-time bidding agent 214 may only permit an increase of an original advertisement bid associated with an advertisement. In instances that a real-time bid is determined to be provided or used, the real-time bidding agent 214 can provide a default advertisement bid (e.g., a predetermined bid associated with a particular advertisement or a set of advertisements) or automatically determine a real-time bid to provide, for example, in accordance with the received advertisement context.

In determining whether to provide a real-time advertisement and/or an advertisement to provide (e.g., a new advertisement, an advertisement modification, or advertisement data), the real-time bidding agent 214 can utilize received advertisement context, such as the search query and user attributes, to make such a determination(s). In some implementations, the real-time bidding agent 214 may be able to provide a new or modified advertisement, provide an advertisement modification, or provide an advertisement supplement. In other implementations, the real-time bidding agent 214 may only permit a particular form of advertisement provision. In instances that a real-time advertisement is determined to be provided or used, the real-time bidding agent 214 can provide a default advertisement (e.g., a predetermined new advertisement associated with a particular originally-provided advertisement or a set of advertisements) or automatically determine a real-time advertisement, or modification or supplementation, to provide, for example, in accordance with the received advertisement context. For example, supplemental context or a change to the advertisement title might be dynamically generated and provided based on the words used in a search query and/or a user attribute (e.g., a user interest, a user demographic, a user location, etc.).

In some embodiments, the real-time bidding agent 214 might provide a relevance score that indicates the relevance of an advertisement(s) to the query. In this regard, upon receiving an indication of an advertisement(s) selected for participation in an advertisement auction, the real-time bidding agent 214 might determine relevance of the selected advertisement to the query, for example, based on analysis performed at the advertiser device or other device. As can be appreciated, in some cases, such an analysis might include rules, algorithms, etc. used in facilitating real-time bids and/or real-time advertisements. A relevance score, as used herein, can be a value indicating an extent of relevance that the advertiser (e.g., real-time bidding agent) believes the advertisement is to the query and/or advertisement context. Such a relevance score could be used by the advertisement selection engine 206 to improve advertisement selection and/or advertisement auction performance.

The advertisement selection engine 206 is configured to facilitate selection of an advertisement for presentation in association with a web page (e.g., a search results page). In embodiments, the advertisement selection engine 206 includes an advertisement selecting component 216, a real-time bidding component 218, and an auctioning component 220.

The advertisement selecting component 216 is configured to select a set of advertisements for participation in an advertisement auction. Initially, the advertisement selecting component 216, or other component, can receive a request for display of a webpage or a search query, for example, provided by a user via a search engine webpage. For example, the web browser 210 of user device 202 may provide (e.g., directly or indirectly) a search query to the advertisement selection engine 206. Upon receiving a request for a webpage and/or search results associated with a particular search query, the advertisement selecting component 216 selects one or more advertisements deemed relevant, for example, to the webpage and/or search query.

The advertisement selecting component 216 can select any number of advertisements for potential display. In some cases, the number of advertisements selected might be predetermined. In other cases, the number of advertisements may vary in accordance with the search query or the requested web page. Further, the advertisement selecting component 216 can select one or more advertisements for potential display in any number of manners. In some embodiments, one or more advertisements might be selected based on relevance to the search query, user attributes, etc. In this regard, advertisements associated with keywords that match terms used in the search query may be identified, for instance.

The real-time bidding component 218 is configured to facilitate real-time bidding. In this way, real-time bidding component 218 facilitates obtaining real-time bids and/or real-time advertisements. In embodiments, upon an indication of a selected advertisement(s), the real-time bidding component 218 can provide a real-time auction indicator to a real-time bidding agent associated with an advertiser of the selected advertisement to identify if a real-time bid and/or real-time advertisement is desired for participation in the advertisement auction. In this regard, a call or request can be made to the real-time bidding agent associated with a selected advertisement. Such a call can include an indication of the selected advertisement(s) and related advertisement context (e.g., search query, user attribute(s), etc.).

The real-time auction indicator can be directed to a real-time bidding agent associated with an advertiser that provided the selected advertisement. In this regard, the real-time bidding component 218, or other component, might be configured to identify a real-time bidding agent (or advertiser or advertiser device) to which to direct the real-time auction indicator. By way of example only, assume that Advertisement A was selected by the advertisement selecting component 216 as a potential advertisement for display. In such a case, the real-time bidding component 218 may identify that a real-time auction indicator is to be transmitted to the real-time bidding agent associated with Advertisement A.

In addition to transmitting a real-time auction indicator, advertisement context data can be communicated to the appropriate real-time bidding agent. Such advertisement context data can be included with the real-time auction indicator or independent of the real-time auction indicator. Such context data may include, for example, a search query (or portion or indication thereof), an indication or identification of a selected advertisement, a user attribute, or the like. A user attribute may be a user identifier that uniquely identifies the user, a user demographic, a user geographical location, a user interest, an indication(s) of web browsing history (e.g., web pages visited and point in time each web page was visited), web searches performed by the user (e.g., search queries submitted by user and/or search results selected by the user in response to the search queries), an indication(s) of user's spending habits (e.g., types of products and services purchased, price level of the purchases, etc.), an indication(s) of advertisements delivered to the user (e.g., type and number of advertisements delivered and user's interaction with the advertisements), an indication of user's computer activities (e.g., session length or information from the user's email), or the like.

In some cases, such context data, such as a user attribute(s), might be referenced and, thereafter, communicated. For example, a data store or index including user data might be accessed to lookup user data associated with the user that input the search query. Context data, or a portion thereof (e.g., user attributes), may be stored in a user profile that is continuously updated. Such a user profile can reside at or be accessible by the advertisement selection engine 206 such that the advertisement selection engine 206 can reference and provide user attributes along with an indication of a selected advertisement for use by the real-time bidding agent 214 in participating in an auction.

As can be appreciated, in some cases, a user identified by an advertisement selection engine 206 may be inconsistent with a user identification desired by the advertiser device 204. For example, an advertiser associated with the advertiser device 204 might know a user to be identified as user ABC, but the advertisement selection engine might know a user to be identified as 123. As such, in some implementations, the real-time bidding component 218, or another component, might identify a user identifier that would be recognizable by the advertiser device 214 such that the user device 204 can use the information appropriately. Such a third-party user identifier might be looked up and, thereafter, transmitted to the real-time bidding agent.

In some cases, before a real-time auction indicator is communicated to an appropriate real-time bidding agent, such as real-time bidding agent 214 of the advertiser device 204, the real-time bidding component 218 might reference and analyze real-time bidding preferences to determine whether a real-time auction indicator should be communicated. In this regard, for a selected advertisement, the real-time bidding component 218 can identify if the advertisement is eligible or set-up for real-time bidding. For example, as previously described, an advertiser may indicate an interest in participating in real-time bidding for an advertisement, a set of advertisements, or all advertisements. Further, any real-time bidding preferences or criteria associated with the advertisement, advertiser, or real-time bidding agent can be referenced and analyzed to determine if the current circumstances permit transmitting the real-time auction indicator. As such, the real-time bidding component 218 might lookup criteria input or selected by an advertiser, and determine whether to generate a call to a real-time bidding agent. For example, an advertiser might input a preference to partake in real-time bidding when a user is located in a particular region. In such a case, the real-time bidding component 218 can reference the preference and determine or identifier if the user is in the particular region. If so, a real-time auction indicator can be generated and transmitted to the real-time bidding agent associated with the advertiser.

In some embodiments, the real-time bidding component 218 might be configured to time out when the real-time bidding agent does not respond within a predetermined time period. In this regard, the advertisement auction can proceed when the bidding agent fails to respond in the specified time period.

Upon receiving real-time bids and/or real-time advertisements from the real-time bidding agent 214, the real-time bidding component 218 can apply the data in association with an advertisement auction. In this regard, any received real-time bids, advertisements, or data associated therewith can be used to participate in an advertisement auction or used as a result of an advertisement auction. For example, assume that a real-time bidding agent participates in real-time bidding by placing a bid value of two cents (e.g., an increase from one cent) for participating in an advertisement auction as well as providing a modified advertisement. In such a case, the real-time bidding component 218 might provide the adjusted advertisement bid of two cents to the auctioning component 220 for participation in the auction. Now assume that the advertisement associated with the two cent bid is successful in the auction. The real-time bidding component 218 could provide the modified advertisement for transmission to a user. In some implementations, the real-time bidding component might communicate the modified advertisement to the user device (e.g., after the advertisement is selected in the advertisement auction). In other implementations, the real-time bidding component might provide the advertisement to the auctioning component 220 (e.g., at auction time or after advertisement selection) for provision to the user device, if applicable.

In some cases, the real-time bidding component 218 might determine whether to apply or utilize any received real-time bids and/or real-time advertisements for participating in an advertisement auction. In this way, the real-time bidding component 218 can elect to reject the real-time recommendation from an advertiser and, instead, use the original bid or advertisement for participation in the auction. An election to reject a real-time recommendation may occur for any number of reasons or defined policies. For example, a real-time bid might be rejected if it is of a lesser monetary value than an originally placed bid.

Received real-time bids and/or real-time advertisements can be logged and/or stored for subsequent usage. For example, a modified or updated bid and/or advertisement might be logged to capture the modification. Further, any advertisements might be stored, for instance, until completion of the advertisement auction. Any advertisement selected can then be accessed and communicated to a user.

The auctioning component 220 is configured to facilitate an advertisement auction to select or identify an advertisement(s) for presentation in association with a web page, such as a search results page. Upon receiving real-time bids and/or real-time advertisements, such data can be used to participate in an advertisement auction associated with a submitted search query. In some embodiments, the advertisement auction can be performed with the real-time data along with non-real-time data, that is, original bids and/or advertisements. In this regard, a real-time bid and corresponding real-time advertisement, if applicable, can participate in an advertisement auction with other real-time bids/advertisements as well as bids/advertisements submitted in a traditional manner (i.e., non-real-time manner). In other embodiments, the advertisement auction can be performed using only real-time data. In this way, a real-time bid and/or corresponding real-time advertisement can participate in an advertisement auction with only other real-time bids/advertisements. The auctioning component 220 can utilize any data to perform the advertisement auction, such as, for example, advertisement bids, advertisement content, click-through-rates, conversion rates, user attributes, and/or the like.

Auctioning component 220 can also provide or facilitate advertisement provision of selected advertisements. In this regard, upon selecting one or more advertisements for presentation to the user, the auctioning component 220 can communicate the selected advertisement(s), or an indication thereof, to the user device for display. In other cases, the auctioning component 220 can provide the selected advertisement(s), or an indication thereof, to another component, such as a search engine, for provision to the user device. Additionally, the auctioning component 220 might provide real-time feedback (e.g., directly or indirectly) to the advertiser (e.g., via real-time bidding agent 214). Such real-time feedback might include, for example, an indication of whether the advertisement was selected for presentation, an indication of the winning bid, or the like. Real-time feedback can be valuable to the advertiser in that, for instance, such feedback could be relevant to adjust the behavior of the real-time bidding agent (e.g., increase subsequent bids).

When the ad agent 214 is triggered, the user data accessing component 302 accesses user data that will be used to determine whether to bid on the current impression. The user data may comprise a variety of different information regarding the end user employing the user device 202 that facilitates determining the relevance and/or value of the end user for an impression.

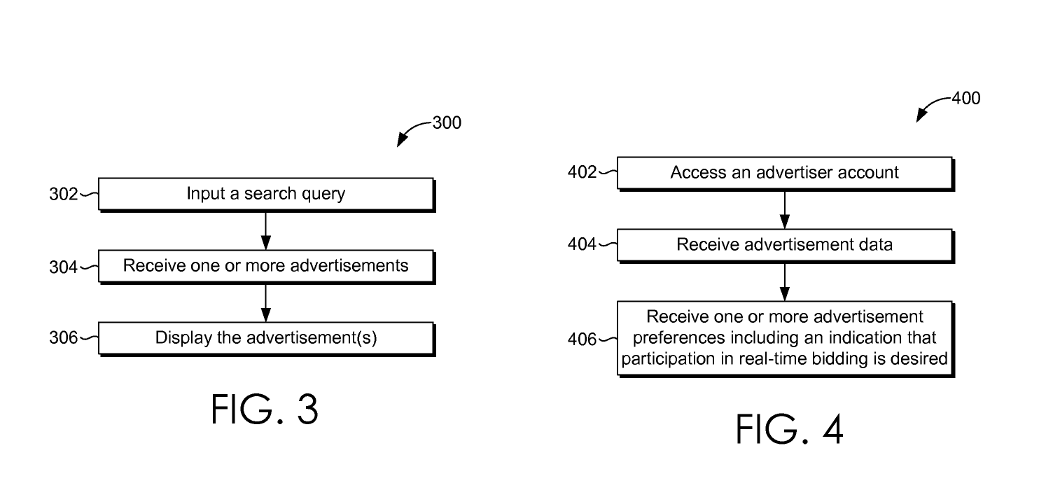

Turning to FIG. 3, a flow diagram is provided that illustrates a method 300 for facilitating presentation of advertisements selected based on real-time bidding in accordance with an embodiment of the present invention. Such a method can be performed, for example, at a user device, such as user device 202 of FIG. 2. As shown at block 302, a user located at a user's computing device inputs or selects a search query. As noted above, advertisement selection can be triggered in a number of different manners. For instance, advertisement selection may be triggered when a web page is accessed that includes a redirect to an advertisement server. In other instances, advertisement selection may be triggered based on the domain of a web page requested by the user.

At block 304, the user device (e.g., via the web browser) receives one or more advertisements (e.g., a real-time advertisement) selected for presentation to the user. As can be appreciated, the one or more advertisements can be selected for presentation based on a real-time bid and/or real-time advertisement provided by an advertiser for participation in an advertisement auction associated with the search query provided by the user. The received advertisement is displayed on a display screen, as indicated at block 306.

Turning now to FIG. 4, a flow diagram is provided that illustrates a method 400 for facilitating inputting advertisement settings in accordance with an embodiment of the present invention. Such a method can be performed, for example, at an advertiser device, such as advertiser device 204 of FIG. 2, or at the advertisement selection engine 206. Initially, as indicated at block 402, an advertiser account is accessed. As can be appreciated, an advertiser account can be accessed by establishing an account or accessing (e.g., logging into) an existing account. At block 404, advertisement data is received. Such advertisement data can include details related to advertisements that the advertiser would like displayed. At block 406, one or more advertisement preferences are received. Such advertisement preferences include an indication that participation in real-time bidding is desired. Preferences may additionally include real-time bidding criteria, display preferences, advertisement bids, advertisement keywords, or the like. The advertisement data and advertisement preferences can thereafter be used for participation in advertisement auctions.

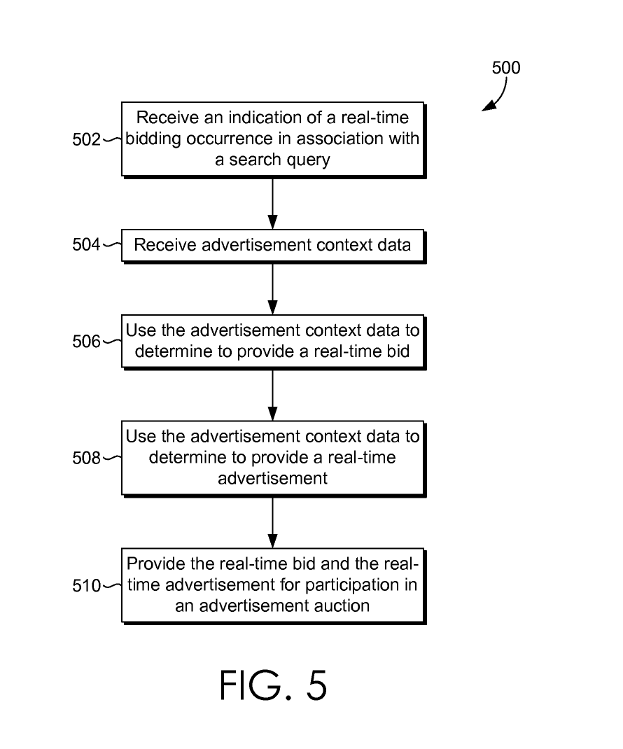

Referring now to FIG. 5, a flow diagram is provided that illustrates a method 500 for facilitating real-time bidding in accordance with an embodiment of the present invention. Such a method can be performed, for example, at an advertiser device, such as advertiser device 204 of FIG. 2. Initially, as indicated at block 502, an indication of a real-time bidding occurrence in association with a search query is received. Such an indication can provide notification that the real-time bidding agent may participate in an auction using a real-time bid and/or a real-time advertisement if desired. At block 504, advertisement context data is received. Real-time context data can be any type of data that provides context to presentation of an advertisement. For example, real-time context data may include the search query, or portion thereof, user attributes related to the user inputting the search query, the selected advertisement, or the like. Although blocks 502 and 504 are illustrated separately, the indication of the real-time auction occurrence and the advertisement context could be received together. For instance, the context data could provide the indication of the real-time auction occurrence.

At block 506, the advertisement context data is used to determine to provide a real-time bid. For example, the advertisement context data may be analyzed and deemed as relevant such that the real-time bid increases the previously provided bid. At block 508, the advertisement context data is used to determine to provide a real-time advertisement. For example, based on the search query, it may be determined to modify the advertisement title to be more relevant to the search query. Thereafter, the real-time bid and the real-time advertisement are provided for participation in an advertisement auction, as indicated at block 510. In some embodiments, the real-time data might compete against other real-time data and/or non-real-time data.

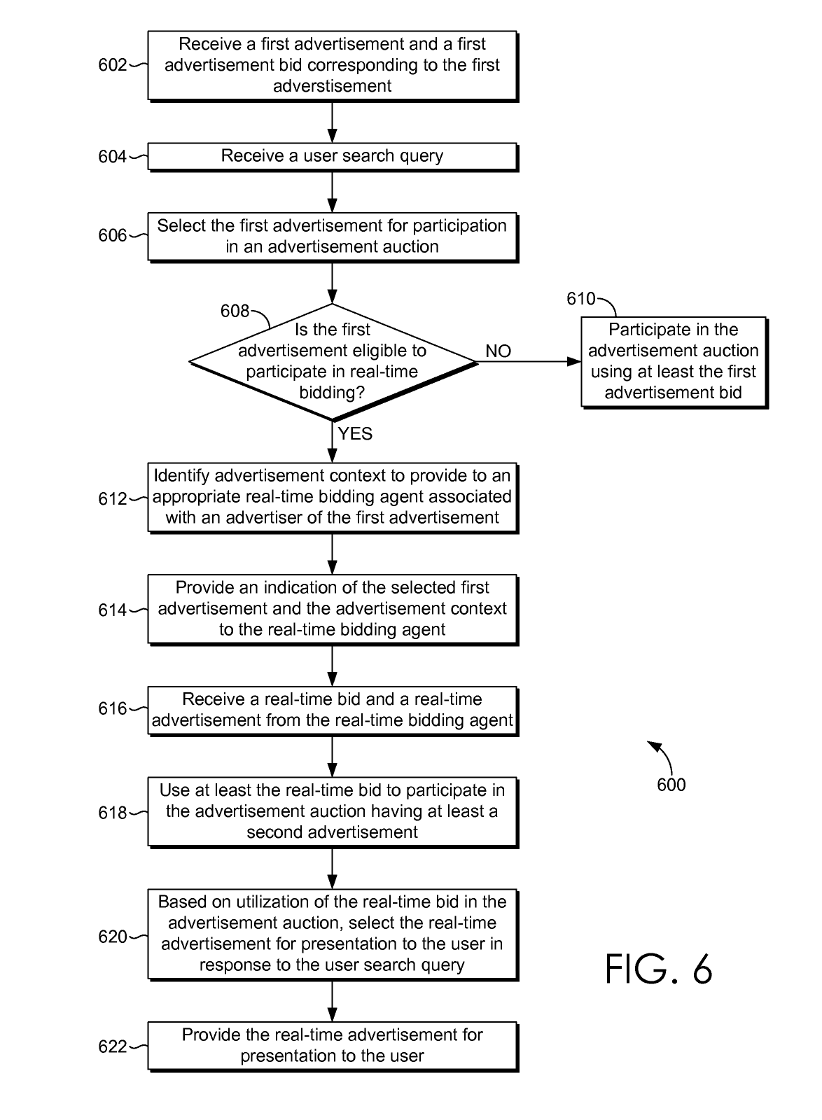

With reference now to FIG. 6, a flow diagram is provided that illustrates a method 600 for facilitating real-time bidding in accordance with an embodiment of the present invention. Such a method can be performed, for example, at an advertisement selection engine, such as advertisement selection engine 206 of FIG. 2. Initially, as indicated at block 602, a first advertisement and a first advertisement bid corresponding to the first advertisement is received. Such an advertisement and corresponding bid can be provided, for instance, by an advertiser device based on input by an advertiser. Thereafter, at block 604, a user search query is received. The user search query may be provided by a user device based on input by a user.

At block 606, the first advertisement is selected for participation in an advertisement auction. The first advertisement might be selected in any manner or for any number of reasons. In embodiments, the first advertisement is selected at least based on relevance to the user search query. At block 608, it is determined if the first advertisement is eligible to participate in real-time bidding. If it is determined that the first advertisement is not eligible to participate in real-time bidding, at least the first advertisement bid originally placed prior to receiving the search query is used to participate in the advertisement auction, as indicated at block 610. On the other hand, if it is determined that the first advertisement is not eligible to participate in real-time bidding, at block 612, advertisement context is identified to provide to an appropriate real-time bidding agent associated with an advertiser of the first advertisement. Advertisement context may include, for instance, user data describing the user or user actions of the user that provided the search query. As such, one or more user attributes related to the user may be looked up and provided as advertisement context along with the search query.

Thereafter, at block 614, an indication of the selected first advertisement and the advertisement context is provided to the real-time bidding agent. In some embodiments, prior to providing such data to the real-time bidding agent, criteria may be analyzed to identify whether the present instance is appropriate for the real-time bidding agent's participation in real-time bidding (e.g., based on user attributes, user search query, etc.). In response, a real-time bid and a real-time advertisement associated with the selected first advertisement is received from the real-time bidding agent. This is indicated at block 616. As previously described, the real-time bid and real-time advertisement can be a new bid/advertisement or modified or supplemental data.

Subsequently, at block 618, at least the real-time bid is used to participate in the advertisement auction having at least a second advertisement. Such a second advertisement may or may not be associated with real-time bidding. At block 620, the real-time advertisement is selected for presentation to the user in response to the user search query based at least on utilization of the real-time bid in the advertisement auction. As such, at block 622, the real-time advertisement is provided (e.g., directly or indirectly) to the user device for presentation to the user. As can be appreciated, the real-time advertisement can be presented to the user in association with the requested web page (e.g., search results page).

The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and subcombinations are of utility and may be employed without reference to other features and subcombinations. This is contemplated by and is within the scope of the claims.

What is claimed is:

1. One or more computer storage media storing computer-useable instructions that, when used by a computing device, cause the computing device to perform a method comprising:
receiving an advertisement and a corresponding advertisement bid for participation in advertisement auctions;
receiving an indication of a desire to partake in real-time bidding at least for one or more advertisement auctions in which the advertisement is participating; and
providing the advertisement, the corresponding advertisement bid, and the indication of the desire to partake in real-time bidding such that real-time bidding is eligible for subsequent advertisement auctions in which the advertisement is participating, wherein the real-time bidding enables provision of at least a real-time bid or a real-time advertisement for participation in the subsequent advertisement auctions associated with received search queries.

2. The one or more computer storage media of claim 1 further comprising one or more criteria indicating instances in which partaking in the real-time bidding is desired.

3. The one or more computer storage media of claim 2, wherein the one or more criteria comprise criteria related to user attributes of users that provide the received search queries, criteria related to the received search queries, or a combination thereof.

4. The one or more computer storage media of claim 3, wherein the user attributes comprise one or more of a user identifier, a user location, a user demographic, a user's search history, a user's purchasing history, or a combination thereof.

5. The one or more computer storage media of claim 1 further comprising providing an option for an advertiser to select or input the indication of the desire to partake in real-time bidding at least for one or more advertisement auctions.

6. The one or more computer storage media of claim 1, in accordance with providing the advertisement, the corresponding advertisement bid, and the indication of the desire to partake in real-time bidding, receiving an opportunity to participate in real-time bidding for a subsequent advertisement auction in which the advertisement is participating.

7. The one or more computer storage media of claim 6, receiving a real-time bid, a real-time advertisement, or a combination thereof for participating in the subsequent advertisement auction.

8. One or more computer storage media storing a real-time bidding agent, the real-time bidding agent including a plurality of components comprising:
a receiving component receives advertisement context data that is related to presentation of an advertisement in response to a search query;
a determining component that determines a real-time bid and a real-time advertisement for participation in an advertisement auction associated with the search query using the advertisement context data; and
a providing component that provides to an advertisement selection server the real-time bid and the real-time advertisement for participation in the advertisement auction associated with the search query.

9. The one or more computer storage media of claim 8, wherein the advertisement context data comprises one or more user attributes and at least a portion of the search query.

10. The one or more computer storage media of claim 9, wherein the one or more user attributes comprise one or more of a user identifier, a user location, a user demographic, a user's search history, a user's purchasing history, or a combination thereof.

11. The one or more computer storage media of claim 8, wherein a real-time bid comprises an advertisement bid that is provided in real-time prior to or concurrent with the advertisement auction.

12. The one or more computer storage media of claim 11, wherein the real-time bid is a new advertisement bid or an adjustment value to be made to a previously provided advertisement bid.

13. The one or more computer storage media of claim 8, wherein the real-time advertisement comprises an advertisement that is provided in real-time prior to or concurrent with the advertisement auction.

14. The one or more computer storage media of claim 13, wherein the real-time advertisement is a new advertisement, an adjustment to be made to a previously provided advertisement, or an addition to be supplemented to a previously provided advertisement.

15. One or more computer storage media storing computer-useable instructions that, when used by a computing device, cause the computing device to perform a method comprising:
receiving an advertisement and a corresponding advertisement bid provided by an advertiser;
receiving a user search query provided by a user;
in accordance with the user search query, selecting the advertisement for participation in an advertisement auction;
providing an indication of the selected advertisement, at least a portion of the user search query, and one or more user attributes associated with the user to a real-time bidding agent associated with the advertiser;
receiving real-time bid and a real-time advertisement from the real-time bidding agent for use in the advertisement auction associated with the user search query; and
using at least the real-time bid for participation in the advertisement auction, wherein the advertisement auction performs selection of one or more advertisements to present in accordance with the user search query.

16. The one or more computer storage media of claim 15 further comprising determining that the selected advertisement is eligible to participate in real-time bidding.

17. The one or more computer storage media of claim 15, wherein the one or more user attributes comprise one or more of a user identifier, a user location, a user demographic, a user's search history, a user's purchasing history, or a combination thereof.

18. The one or more computer storage media of claim 15 further comprising referencing the one or more user attributes associated with the user.

19. The one or more computer storage media of claim 15 further comprising selecting the real-time advertisement for presentation to the user in response to the user search query based on utilization of the real-time bid in the advertisement auction.

20. The one or more computer storage media of claim 19, further comprising providing the real-time advertisement for presentation to the user.
